(19) United States
(12) Patent Application Publication
(10) Pub. No.: US 2009/0075068 A1
(43) Pub. Date: Mar. 19, 2009

(54) Electromagnetic wave absorbing and shielding film, method of manufacturing the same, and cable including the same

(75) Inventors: Jung Seok Pyo, Yongin-si (KR); Jong Young Lee, Seongnam-si (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: EMPKO CO., LTD.

(21) Appl. No.: 11/987,990

(22) Filed: Dec. 6, 2007

(30) Foreign Application Priority Data
Sep. 13, 2007 (KR) 10-2007-0092899

(51) Int. Cl. B32B 7/00; B05D 5/12; B32B 37/00; H01B 13/00

(52) U.S. Cl. 428/336; 427/77; 156/47; 428/334; 428/335

(57) ABSTRACT

Disclosed herein are an electromagnetic wave absorbing and shielding film, a method of manufacturing the same, and a cable including the electromagnetic wave absorbing and shielding film. The electromagnetic wave absorbing and shielding film includes an electromagnetic wave absorbing layer, in which a plate-like metal flake is formed using a metal powder in the form of a paste or ink, and an electromagnetic wave shielding layer attached to the electromagnetic wave absorbing layer, thus absorbing and shielding electromagnetic wave and reducing noise.

For this, the present invention provides a method of manufacturing an electromagnetic absorbing and shielding film, in which the method includes forming a plate-like metal flake using a spherical metal alloy by an attrition mill, which operates at a predetermined speed for a predetermined time, with the addition of steel use stainless (SUS) balls or ceramic balls and surfactants, and washing the plate-like metal flake with ethyl alcohol, methyl alcohol or water and drying the washed metal flake, the method including: mixing the metal flake powder with resin in a ratio of 30 to 95 wt %:70 to 5 wt % using a mixer and stirring the same to form a metal paste; and coating the metal paste on an electromagnetic wave shielding layer, and a communication cable including the thus formed electromagnetic wave absorbing and shielding film.

### CROSS-REFERENCE TO RELATED APPLICATION

This application claims the benefit of Korean Patent Application No. 10-2007-0092899, filed on Sep. 13, 2007, the entire disclosure of which is hereby incorporated by reference.

### BACKGROUND OF THE INVENTION

1. Field of the Invention

The present invention relates to an electromagnetic wave absorbing and shielding film and, more particularly, to an electromagnetic wave absorbing and shielding film, in which an electromagnetic wave absorbing layer capable of absorbing electromagnetic wave is formed on a support capable of shielding electromagnetic wave, a method of manufacturing the same, and a cable including the electromagnetic wave absorbing and shielding film.

2. Description of Related Art

Recently, with the rapid increase the use of various electrical and electronic devices, there arises a problem of electronic noise or electromagnetic interference (EMI). Such noises may be classified into conduction noise, emission or radiation noise, and the like.

Typically, a noise filter is used to reduce the conduction noise, and a specific space is electromagnetically insulated to prevent the emission or radiation noise.

For this, an electrical or electronic device may be placed in a metal or conductive case, a metal plate may be disposed between two circuit boards, the periphery of a cable may be enclosed by a metal foil, or an electromagnetic wave absorber may be applied to the electrical or electronic device.

Such electromagnetic wave absorbers include a rubber sheet using a metal compound; however, since the rubber sheet comprises inorganic materials and polymers mechanically mixed, it has some problems in that its properties are sensitive, heat resistance is decreased, and thus the efficiency of absorbing electromagnetic wave is reduced.

Especially, in the case of such a rubber sheet, since a resin containing chlorine-polyethylene (halogens) is employed, it may cause damage to the human bodies and peripheral devices due to toxic gases such as Cl, F, and the like.

Moreover, since most existing electromagnetic wave absorbers are formed of basic materials such as carbon, ferrite, metal, and the like, they have various problems in that the process is difficult, it is hard to adjust the thickness of the absorber, they are not competitive in price due to high manufacturing cost, they are not resistant to abrasion due to lack of flexibility and elongation, and the adjustment of the applied frequency is difficult.

As an improved electromagnetic wave absorber, there has been developed an electromagnetic interference gasket applied to a cellular phone, a PDA device, and the like. The electromagnetic interference gasket is formed by wrapping the outside of a sponge with a metal coated fiber to prevent leakage of electromagnetic wave from an internal module of the cellular phone or PDA device.

However, even in the case of the electromagnetic interference gasket, there are numerous problems resulting from fiber characteristics. For example, an electrical short may be formed by a scrap of thread of the cut region of the gasket, and thus it causes a malfunction of the device to which the gasket is applied.

Accordingly, various electromagnetic wave absorbers using metal alloy materials capable of solving the problems of the above electromagnetic wave absorbers have been developed and widely applied to cellular phones, LCD devices, PDA devices, and the like.

For example, typical raw materials used as the electromagnetic wave absorbers may include sendust (SDST) alloy, High-Flux powder, molypermalloy powder (MPP), pure iron alloy (Fe—Si, or Fe—Si—Cr), amorphous alloy (Fe—Si—Al—Cr), carbon coated iron, Ni—Zn ferrite powder, and Mn—Zn ferrite powder.

Such powders have a spherical shape with an aspect ratio of 1:1 to 5 and are applied in the form of a paste or sheet to form electromagnetic wave absorbers.

However, in the event that the spherical metal alloy is used as a raw material to form a sheet, the amount of the metal alloy laminated inside the sheet is too small to achieve a sufficient electromagnetic wave absorption performance. Moreover, since it is difficult to increase the thickness of the sheet due to the restrictions on available space in the applied device. Accordingly, there are disadvantages in terms of function and cost.

That is, since the raw material powder used as the electromagnetic wave absorber has a spherical shape, magnetic permeability is decreased. Accordingly, there are limitations on the frequency range to be applied and the absorption efficiency is significantly decreased in the high frequency range.

In consideration of the above circumstances, the present inventor and applicant have disclosed an electromagnetic wave absorber and a method of manufacturing the same in Korean Patent No. 10-0463593, registered on Dec. 16, 2004, in which the method comprises a process of forming a plate-like metal flake using a spherical metal alloy by an attrition mill, a process of pasting the plate-like metal flake with resin through a high-speed stirring process, and a process of sheeting the metal paste on a release film through a laminating process. Accordingly, the pasted or sheeted electromagnetic wave absorber can be formed with various shapes or forms. Moreover, since the electromagnetic wave absorber shows excellent electromagnetic wave absorption performance, it can be widely applied, to various electronic devices having a small size and complicated structure such as a cellular phone, an LCD device, a drive IC, a PDA device, a wireless LAN, and the like. Furthermore, it is possible to increase the aspect ratio without destruction of the metal alloy shape and ensure a laminated alignment structure capable of increasing the absorption rate in the case of the sheeted absorber. Accordingly, the electromagnetic wave absorber can show excellent electromagnetic wave absorption effect in the high frequency range.

Recently, with the development of communication devices, electromagnetic wave is formed in a communication cable connected between the communication devices. As shown in FIG. 1, a copper braided shield 80 knitted into a network structure encloses a communication line 40, a power line 50 and an earth wire 60 included in a cable 200 so as to reduce the noise caused by electromagnetic wave.

Moreover, as another method of shielding electromagnetic wave applied to the communication cable connected between communication devices, a ceramic core is used instead of the copper braided shield, or an electromagnetic wave absorbing sheet is attached to the inside of an outlet connected to an end of the cable.

Accordingly, the copper braided shield can shield the electromagnetic wave generated from the communication line and the power line; however, the electromagnetic wave shielding effect is reduced as can be understood from the graph of FIG. 5 showing the results of an Experimental Example.

### SUMMARY OF THE INVENTION

The present invention provides an electromagnetic wave absorbing and shielding film and a method of manufacturing the same comprising forming a plate-like metal flake using a metal powder or ferrite powder, dispersing the metal flake into a binder solution, coating the resulting solution in which the metal flake is dispersed on a support capable of shielding electromagnetic wave, and drying the support coated with the metal flake. The thus formed electromagnetic wave absorbing and shielding film is applied to an electrical wire and communication cable where electromagnetic wave is generated, thus absorbing and shielding electromagnetic wave and reducing noise.

Moreover, the present invention provides a communication cable in which the electromagnetic wave absorbing and shielding film is installed to wrap a communication line, a power line and an earth wire, thus absorbing and shielding electromagnetic wave generated from the communication cable and reducing noise between communication devices.

In accordance with an aspect of the present invention, there is provided a method of manufacturing an electromagnetic absorbing and shielding film, in which the method comprises forming a plate-like metal flake using a spherical metal alloy by an attrition mill, which operates at a predetermined speed for a predetermined time, with the addition of steel use stainless (SUS) balls or ceramic balls and surfactants, and washing the plate-like metal flake with ethyl alcohol, methyl alcohol or water and drying the washed metal flake, the method comprising: dispersing powder capable of absorbing electromagnetic wave selected from the group consisting of Fe—Si alloy, Fe—Si—Cr alloy, amorphous substance, sendust (SDST) alloy, High-Flux powder, molypermalloy powder (MPP), pure iron alloy (Fe—Si, or Fe—Si—Cr), amorphous alloy (Fe—Si—Al—Cr), carbon coated iron, Ni—Zn ferrite powder, Mn—Zn ferrite powder, and a mixture thereof, into a binder solution, thus forming electromagnetic wave absorbing paint; and coating the electromagnetic wave absorbing paint on the surface of a film capable of shielding electromagnetic wave and drying the resulting film, thus forming an electromagnetic wave absorbing and shielding film, of which one side is an electromagnetic wave absorbing layer having a thickness in a range of 10 to 100 μm and the other side is an electromagnetic wave shielding layer.

The electromagnetic wave shielding layer may be formed by one of the steps of: 1) laminating a metal thin film as an electrical conductive layer selected from the group consisting of aluminum foil, copper foil, silver foil, and nickel foil on a polymer film selected from the group consisting of polyethylene terephthalate, polyethylene naphthalate, polyaramide, polycarbonate, polyamide, polyimide, polyamideimide, and aramid; 2) depositing a metal component as an electrical conductive layer selected from the group consisting of Al, Cu, Ag, and Ni on the polymer film; and 3) dispersing a metal component as an electrical conductive layer selected from the group consisting of Al, Cu, Ag and Ni into a binder solution and coating the resulting solution on the polymer film, wherein the electrical conductive layer has a thickness in a range of 5 to 20 μm, the polymer film has a thickness in a range of 12 to 50 μm, and the total thickness of the electromagnetic wave shielding layer is in a range of 17 to 70 μm.

In accordance with another aspect of the present invention, there is provided a communication cable in which a communication line, a power line, and an earth wire are wrapped with an insulating coating, the communication cable comprising the above-described electromagnetic wave absorbing and shielding film, wherein the electromagnetic wave absorbing and shielding film installed inside the insulating coating wraps the communication line, the power line and the earth wire, of which the electromagnetic wave shielding layer is arranged toward the communication line, the power line and the earth wire and the electromagnetic wave absorbing layer is arranged toward the insulating coating.

A drain wire having excellent electrical conductivity may be arranged inside the electromagnetic wave shielding layer together with the communication line, the power line and the earth wire, and the electromagnetic wave shielding layer may be grounded to the earth wire by the drain wire.

### BRIEF DESCRIPTION OF THE DRAWINGS

FIG. 1 is a schematic diagram illustrating a copper braided shield formed in a conventional communication cable as an alternative way of reducing noise caused by electromagnetic wave;

FIG. 2 is a schematic diagram illustrating an electromagnetic wave absorbing and shielding film in accordance with the present invention;

FIG. 3 is a schematic diagram illustrating a communication cable including an electromagnetic wave absorbing and shielding film in accordance with the present invention;

FIG. 4 is a graph showing the results of noise test on a communication cable including no electromagnetic wave absorbing and shielding material in accordance with the present invention;

FIG. 5 is a graph showing the results of noise test on a communication cable including an electromagnetic wave absorbing and shielding film in accordance with the present invention;

FIG. 6 is an electron microscope photograph showing a metal flake used in an electromagnetic wave absorbing layer in accordance with the present invention; and

FIG. 7 is an electron microscope photograph showing an electromagnetic wave absorbing layer formed of a metal flake in the form of a sheet in accordance with the present invention.

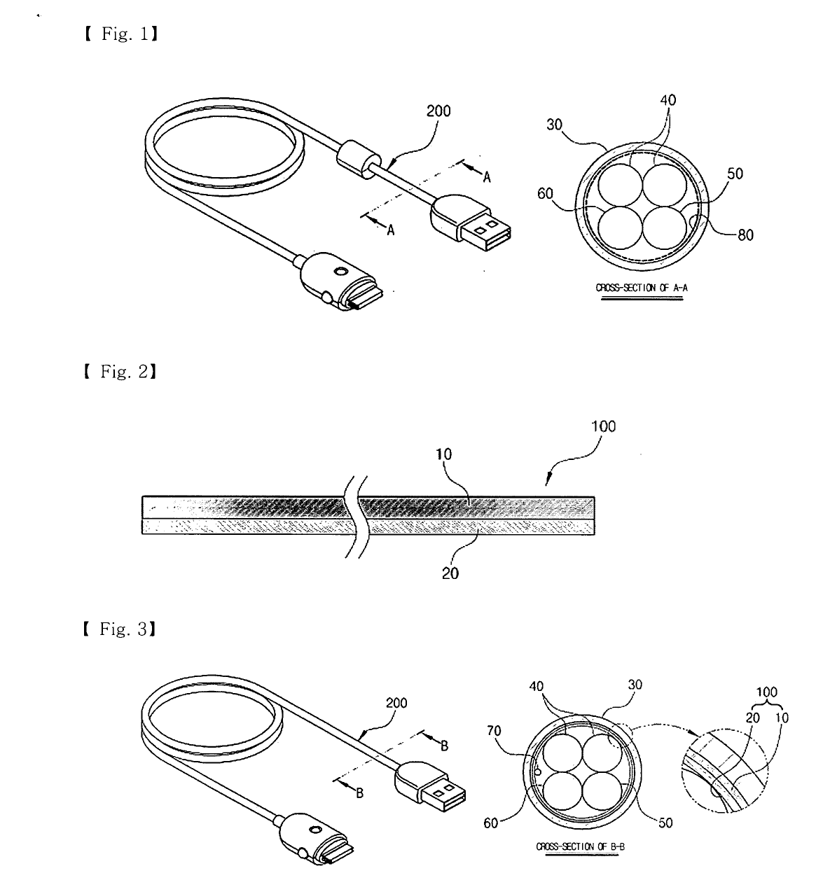

### DETAILED DESCRIPTION OF THE INVENTION

Hereinafter, preferred embodiments in accordance with the present invention will be described with reference to the accompanying drawings. The preferred embodiments are provided so that those skilled in the art can sufficiently understand the present invention, but can be modified in various forms and the scope of the present invention is not limited to the preferred embodiments.

The present invention provides an electromagnetic wave absorbing and shielding film and a method of manufacturing the same comprising a process of forming a plate-like metal flake using a spherical metal alloy by an attrition mill, which operates at a predetermined speed for a predetermined time, with the addition of steel use stainless (SUS) balls or ceramic balls and surfactants, a process of washing the plate-like metal flake with ethyl alcohol, methyl alcohol or water and drying the washed metal flake, a process of manufacturing slurry, a coating process, and a cutting process.

FIG. 2 is a schematic diagram illustrating an electromagnetic wave absorbing and shielding film in accordance with the present invention, and FIG. 3 is a schematic diagram illustrating a communication cable including an electromagnetic wave absorbing and shielding film in accordance with the present invention.

The present invention provides an electromagnetic wave absorbing and shielding film 100, in which an electromagnetic wave absorbing layer 10 and an electromagnetic wave shielding layer 20 overlap each other, and a communication cable 200 including the film installed therein, thus reducing noise on communication signals.

First, a method of manufacturing an electromagnetic wave absorbing layer of the electromagnetic wave absorbing and shielding film in accordance with the present invention will be described below.

The process of forming a plate-like metal flake using a spherical metal alloy by an attrition mill, which operates at a predetermined speed for a predetermined time, with the addition of SUS balls and surfactants, and the process of washing the plate-like metal flake with ethyl alcohol or methyl alcohol and drying the washed metal flake are performed in the same manner as disclosed in Korean Patent No. 10-0463593 by the present inventor and applicant.

In the process of forming the metal flake, the mixed ratio of the metal alloy and the SUS balls may be varied according to the attrition mill used. That is, in the case where a 50 L attrition mill is used, the mixed ratio of metal alloy: Ø15 ball: Ø20 ball=1:2.8 to 4.5:2.3 to 4.2, in the case of a 30 L attrition mill, the mixed ratio of metal alloy: Ø10 ball: Ø15 ball=1:2.8 to 4.5:2.3 to 4.2, in the case of a 10 L attrition mill, the mixed ratio of metal alloy: Ø5 ball: Ø10 ball=1:2.3 to 4.2:2.8 to 4.5, and in the case of a 5 L attrition mill, the mixed ratio of metal alloy: Ø3 ball: Ø5 ball=1:2.3 to 4.2:2.8 to 4.5.

At this time, the metal alloy, which is a raw material for manufacturing the electromagnetic wave absorbing layer, may be any one selected from the group consisting of Fe—Si alloy, Fe—Si—Cr alloy, amorphous substance, sendust (SDST) alloy, High-Flux powder, molypermalloy powder (MPP), Ni—Zn ferrite powder, Mn—Zn ferrite powder, and a mixture thereof, but is not limited thereto. The SUS balls may be SUS301 or SUS304.

The surfactants added in the process of forming the metal flake may include 0.005 to 0.03 wt % of oleic acid, 0.0001 to 0.003 wt % of triethanolamine, 0.005 to 0.03 wt % of tartaric acid, and 0.0002 to 0.004 wt % of formic acid with respect to the metal alloy.

In such a flattening process, the metal alloy powder, the SUS balls and the surfactants are placed into the attrition mill and stirred at 200 to 400 rpm for 3 to 12 hours. Subsequently, the thus formed metal flake powder is washed with ethyl alcohol, methyl alcohol or water and air-dried for 36 to 48 hours or dried in a drier at a temperature of 60 to 120° C. for 6 to 12 hours.

The thus processed metal flake has an aspect ratio of 1:150 to 450 significantly increased compared with the metal allow having that of 1:1 to 5.

In order to form the electromagnetic wave absorbing and shielding film of the invention, the metal flake powder capable of absorbing electromagnetic wave is subjected to a process of forming paint by dispersing the powder into a binder solution, a process of coating the thus formed paint on a support, and a process of slitting the support with a predetermined width.

In the process of forming paint, the metal flake powder capable of absorbing electromagnetic wave is wet-dispersed into the binder solution for binding the powder to the support, thus forming the paint.

The binder used in the process of forming paint may include at least one selected from the group consisting of a polyester polyurethane resin, a vinyl chloride resin, a urethane resin, a polyisocyanate resin, and a mixture thereof. Moreover, the binder may contain at least one functional group selected from the group consisting of —COOM, —OSO₃M, —SO₃M, PO(OM₁)(OM₂), —OPO(OM₁)(OM₂), NR₄X, wherein M, M₁, M₂ denote Li, Na, K, H, —NR₄, or HNR₃, R denotes an alkyl group or H, and X denotes a halogen atom.

In particular, the binder may be selected from the group consisting of UCAR-527, UCAR-569, VAGH, VYHH, VMCH, VAGF, VAGD, VROH, VYES, VYNC, VMCC, XYHL, XYSG, PKHH, PKHJ, PKHC, PKFE, etc., manufactured by Dow Chemical Company; MPR-TA, MPR-TA5, MPR-TAL, MPR-TSN, MPR-TMF, MPR-TS, MPR-TM, MPR-TAO, etc. by Nissin Chemical Industry Co., Ltd.; 100OW, DX80, DX82, DX83, 100FD, etc. by Electrochemical Co. Ltd.; MR105, MR100, MR110, etc. by Nippon Zeon Co. Ltd.; Niporan N2301, N2302 and N2304 by Nippon Polyurethane Co. Ltd.; Pantex T-5105, T-R3080, T-5021, etc. by Dainippon Ink & Chemicals Inc; CA-271, CA-237, CA-2237, CA-236, CA-239, CA-397, CA-398, CA-399, 84847, CA-151HT, CA-152, etc. by Molton Co.; TI-9200, TI-1331, TI-8222, TI-8202, TI-8321, TI-8405, TI-8550, TI-8800, TI-8860, TI-8870, TI-8890, TI-8900, TI-8911, TI-8912, etc. as TI series by Sanyo Chemical Industries Ltd.; 5714F1, 5703P, 5701F1P, 5788P, 5719P, 5715P, 5706P, 5755P, 5778P, 5799P, etc. by B.F. Goodrich Corp; and the like.

An available organic solvent for dissolving the binder may be selected from the group consisting of ketones such as acetone, methylethylketone, methylisobutylketone, diisobutylketone, cyclohexanone, etc.; alcohols such as methanol, ethanol, propanol, butanol, isobutyl alcohol, isopropyl alcohol, methylcyclohexanone, etc.; esters such as methyl acetate, butyl acetate, isobutyl acetate, etc.; glycol ethers such as glycol diethyl ether, glycol monoethyl ether, dioxane, etc.; aromatic hydrocarbons such as benzene, toluene, chlorobenzene, etc.; hydrocarbon chlorides such as methylene chloride, ethylene chloride, carbon tetrachloride, etc.; and the like

Such organic solvents may not have a purity of 100% but may contain isomers, by-products and derivatives of 10% to 30% or less, preferably, impurities of 10% or less.

Moreover, a hardening agent capable of forming a three-dimensional network structure is used to improve the durability of the film, and as the hardening agent, isocyanates having an NCO group in an appropriate amount may be used.

Particularly, the hardening agent may be selected from the group consisting of trilenediisocyanate, 4,4′-diphenylmethane diisocyanate, hexamethylene diisocyanate, xylene diisocyanate, naphthylene-1,5-diiocyanate, triphenylmethane triisocyanate, and the like.

A commonly available disperser such as a kneader, a sand mill, a planetary mixer, a 3-roll mill, and the like may be used to disperse the absorbing powder into the binder solution in which the binder is dissolved.

The coating process is carried out to coat the paint capable of absorbing electromagnetic wave dispersed in the binder solution on a support capable of shielding electromagnetic wave, thus forming a coated film. In the coating process, a coater head such as a gravure coater, a micro-gravure coater, a reverse coater, a die coater and a comma coater may be used to form a coated film with a predetermined thickness. The coated film containing the solvent is subjected to a drying process to form a dried electromagnetic wave absorbing and shielding film including the electromagnetic wave absorbing layer and the electromagnetic wave shielding layer.

Here, the electromagnetic wave absorbing layer may have a thickness of 10 to 100 μm. If the thickness is less than 10 μm, the electromagnetic wave absorption performance may be deteriorated and the tensile strength and elongation of the film is decreased to deteriorate the process characteristics. Whereas, if the thickness is more than 100 μm, the manufacturing cost may be increased and, when the film is applied to a product, it may cause an appearance defect.

The electromagnetic wave shielding layer supporting the absorbing layer and capable of shielding electromagnetic wave may be formed by laminating a metal thin film having excellent electrical conductivity such as aluminum foil, copper foil, silver foil, nickel foil, etc. on a polymer film such as polyethylene terephthalate, polyethylene naphthalate, polyaramide, polycarbonate, polyamide, polyimide, polyamideimide, aramid, etc., by depositing a metal component having excellent electrical conductivity such as Al, Cu, Ag, Ni, etc. on the polymer film, or by dispersing a metal component having excellent electrical conductivity such as Al, Cu, Ag, Ni, etc. into a binder solution and coating the resulting solution on the polymer film. Here, the thickness of the conductive layer having excellent electrical conductivity for shielding electromagnetic wave may be in a range of 5 to 20 μm, and that of the polymer film may be in a range of 12 to 50 μm. Accordingly, the total length of the electromagnetic wave shielding layer may be in a range of 17 to 70 μm.

The reason for limiting the thickness of the electromagnetic wave shielding layer is that if the thickness is small, the electromagnetic wave shielding layer may be broken and the electrical conductivity may be reduced, thus reducing the shielding effect; whereas, if the thickness is large, the manufacturing cost may be increased and it may cause an appearance defect of the final product.

Next, the structure of the communication cable in which the thus manufactured electromagnetic wave absorbing and shielding film is installed will be described below.

As described above, the communication cable 200 includes an insulating coating 30 wound on the outermost layer thereof, a pair of communication lines 40, a power line 50, and an earth wire 60 distributed inside the insulating coating 30.

Here, the electromagnetic wave absorbing and shielding film 100 manufactured as described above in accordance with the present invention is installed in the communication cable 200 to prevent generation of noise between communication devices.

In this case, the electromagnetic wave absorbing and shielding film 100 is arranged in such a manner that the electromagnetic wave shielding layer 20 is arranged toward the communication lines 40, the power line 50 and the earth wire 60, and the electromagnetic wave absorbing layer 10 is arranged toward the insulating coating 30.

Accordingly, the electromagnetic wave absorbing and shielding film 100 of the present invention is installed inside the insulating coating 30 and wraps the communication lines 40, the power line 50 and the earth wire 60 such that the noise generated from the communication lines 40 can be removed by the electromagnetic wave absorbing and shielding film 100.

Moreover, a silver (Ag) drain wire is installed inside the electromagnetic wave absorbing and shielding film 100 together with the communication lines 40, the power line 50 and the earth wire 60. Accordingly, the electromagnetic wave shielding layer 20 of the electromagnetic wave absorbing and shielding film 100 is grounded to the earth wire 60 by the silver drain wire such that electromagnetic wave is grounded to the earth wire 60 by the electromagnetic wave shielding layer 20 and removed.

Next, the effect of shielding electromagnetic wave and the effect of removing noise from the communication cable including the electromagnetic wave absorbing and shielding film in accordance with the present invention will be described in detail with reference to the following Examples, Comparative Examples and Experiment Examples; however, the scope of the present invention is not limited to the Examples.

### EXAMPLES AND COMPARATIVE EXAMPLES

The above-described powder (Fe-based alloy) capable of absorbing electromagnetic wave was dispersed into a binder solution to form paint for absorbing electromagnetic wave.

In order to improve the paint characteristics, additives such as a dispersing agent, an antifoaming agent and a leveling agent were added, in which the powder content was 82%, the binder content was 15%, the dispersing agent content was 1%, the antifoaming agent content was 1% and the leveling agent content was 1%.

The thus formed paint was coated on supports, each having an electromagnetic wave shielding layer and formed by laminating aluminum foil on a polyimide film, thus forming electromagnetic wave absorbing and shielding films having various thicknesses.

The thicknesses of the thus formed electromagnetic wave absorbing layers and shielding layers of the electromagnetic wave absorbing and shielding films were measured and shown in the following table 1.

Moreover, the electromagnetic wave absorbing layers and the electromagnetic wave shielding layers were installed in the communication cables by varying the directions of the electromagnetic wave absorbing layers and the electromagnetic wave shielding layers arranged inside the coatings of the communication cables and wound thereon, and the winding directions were shown in the following table 1.

TABLE 1

| | Thickness | Thickness of Shielding Layer | | | Film Direction | | |
|---|---|---|---|---|---|---|---|
| | of | (μm) | | | Absorbing | Shielding | |
| | Absorbing | Conductive | Polymer | Total | Layer | Layer | |
| Examples | Layer (μm) | Layer | Layer | Length | Direction | Direction | Drain Wire |
| Example 1 | 30 | 9 | 16 | 25 | Coating | Earth Wire | Applied |
| Example 2 | 40 | 9 | 16 | 25 | Coating | Earth Wire | Applied |
| Example 3 | 50 | 9 | 16 | 25 | Coating | Earth Wire | Applied |
| Example 4 | 50 | 15 | 16 | 31 | Coating | Earth Wire | Applied |
| Comparative | 5 | 9 | 16 | 25 | Coating | Earth Wire | Applied |
| Example 1 | | | | | | | |
| Comparative | 100 | 9 | 16 | 25 | Coating | Earth Wire | Applied |
| Example 2 | | | | | | | |
| Comparative | 40 | 4 | 6 | 10 | Coating | Earth Wire | Applied |
| Example 3 | | | | | | | |
| Comparative | 40 | 25 | 75 | 100 | Coating | Earth Wire | Applied |
| Example 4 | | | | | | | |
| Comparative | 40 | 9 | 16 | 25 | Earth Wire | Coating | Applied |
| Example 5 | | | | | | | |
| Comparative | 40 | 9 | 16 | 25 | Coating | Earth Wire | Not Applied |
| Example 6 | | | | | | | |

### Experimental Example 1

The communication cables manufactured in accordance with the Examples and the Comparative Examples were tested as follows to evaluate the workability, the transmission state, the electromagnetic compatibility and the appearance state, and the results are shown in Table 2.

Workability

The workability was evaluated whether or not the operation was carried out satisfactorily without any problems such as breakage during the manufacturing of the communication cables using the electromagnetic wave absorbing and shielding films in accordance with the Examples and the Comparative Examples, and designated as suitable or unsuitable.

Burst Test

The burst test was carried out whether or not the communication data transmission of the cables were satisfactory by transmitting data until the data transmission was completed using Noise Ken FNS-AX2 equipment, and designated as good or bad.

CS Signal Transmission Test

The test was carried out whether or not the CS signal was transmitted using Schafener NSG 2070 RF-Generator, and designated as good or bad.

Electromagnetic Compatibility Test

The electromagnetic compatibility test was performed in an EMI chamber (shield performance: MIL-STD-285; conforming to the site attenuation characteristics defined by ANSI C63.4) using EMC analyzer E7403A equipment, and designated as good or bad.

Appearance Test

The appearance was evaluated after manufacturing the cables and designated as suitable or unsuitable.

TABLE 2

| | | Burst | CS Signal | Electromagnetic | |
|---|---|---|---|---|---|
| Examples | Workability | Test | Transmission Test | Compatibility Test | Appearance |
| Example 1 | Suitable | Good | Good | Good | Suitable |
| Example 2 | Suitable | Good | Good | Good | Suitable |
| Example 3 | Suitable | Good | Good | Good | Suitable |
| Example 4 | Suitable | Good | Good | Good | Suitable |
| Comparative | Suitable | Good | Good | Bad | Suitable |
| Example 1 | | | | | |
| Comparative | Suitable | Good | Good | Good | Unsuitable |
| Example 2 | | | | | |
| Comparative | Unsuitable | Bad | Bad | Good | Suitable |
| Example 3 | | | | | |
| Comparative | Suitable | Good | Good | Good | Unsuitable |
| Example 4 | | | | | |
| Comparative | Suitable | Bad | Bad | Bad | Unsuitable |
| Example 5 | | | | | |
| Comparative | Suitable | Bad | Bad | Bad | Unsuitable |
| Example 6 | | | | | |

As can be ascertained from Table 2, the cables including the electromagnetic wave absorbing and shielding film manufactured in accordance with the present invention showed good results with respect to all the test items and, especially, it can be understood that the data communication characteristics were excellent, the electromagnetic compatibility was excellent, and the appearance was good.

### Experimental Example 2

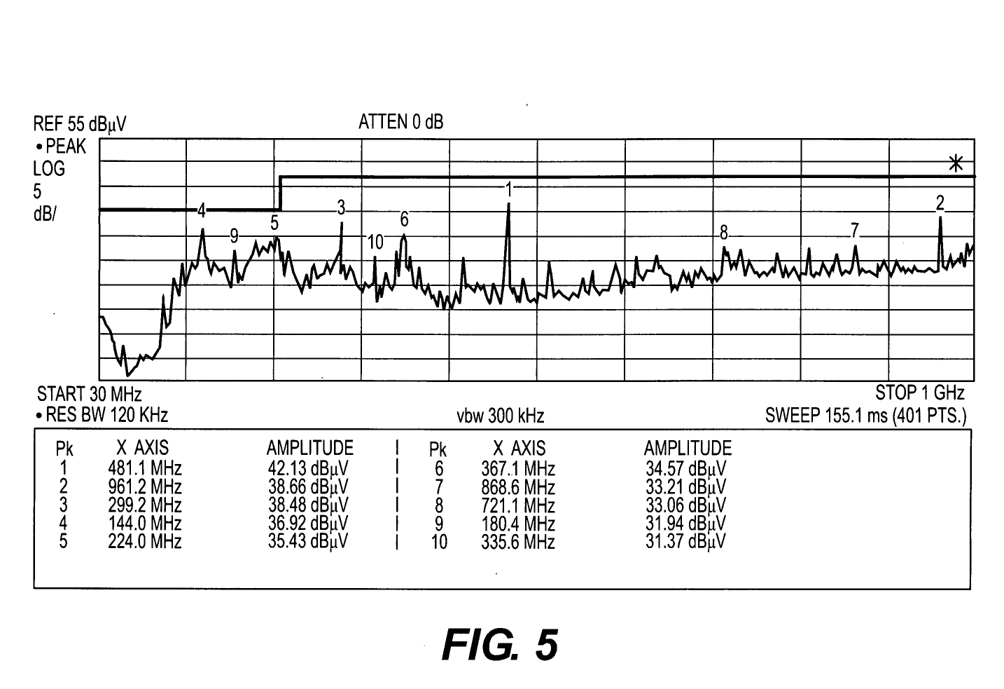

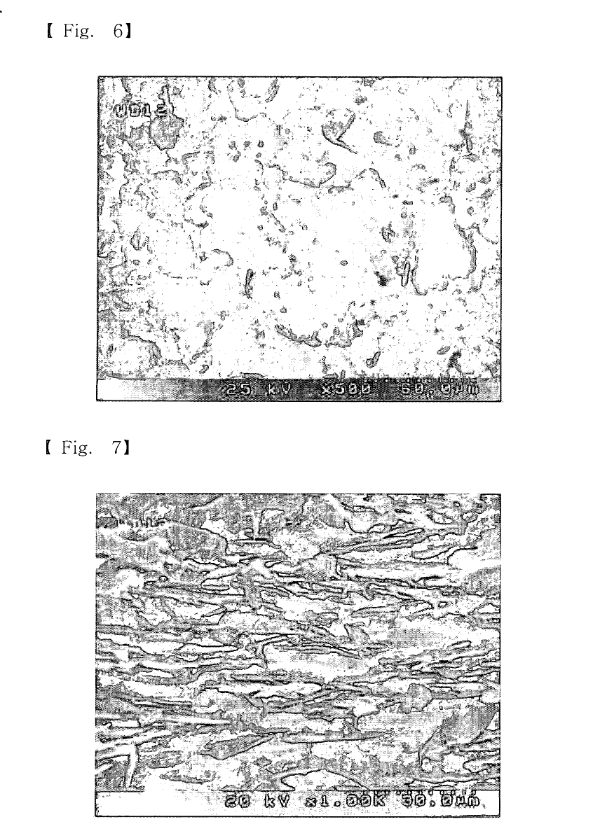

The electromagnetic wave absorbing and shielding film of the present invention was installed inside an insulating coating of USB cable of Samsung Techwin digital camera NV-1-83. That is, communication lines, a power line and an earth wire provided in the USB cable were wrapped with a strip type electromagnetic wave absorbing and shielding film, in which an electromagnetic wave shielding layer having a thickness of 30 μm and an electromagnetic wave absorbing layer having a thickness of 50 μm were bonded. The electromagnetic wave shielding layer was connected to the earth wire with a silver drain wire, and then the electromagnetic compatibility test was carried out in an EMI chamber (shield performance: MIL-STD-285; conforming to the site attenuation characteristics defined by ANSI C63.4) using EMC analyzer E7403A equipment. As can be seen from the results shown in FIG. 5, the results did not exceed the maximum reference value (red line).

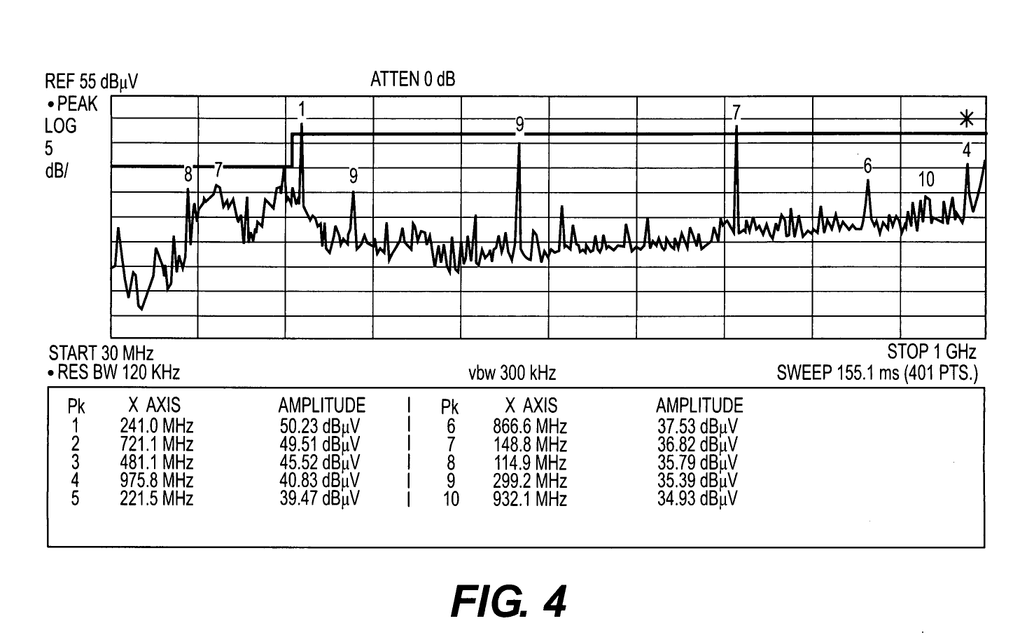

On the other hand, in the case where no means for shielding electromagnetic wave or removing noise was installed in the USB cable of Samsung Techwin digital camera NV-1-83, as shown in the graph of FIG. 4, it can be seen that it exceeded the maximum reference value at frequencies of 241.0 MHz and 721.1 MHz and approached the maximum reference value at a frequency of 481.1 MHz.

Through the above Experimental Example, it can be understood that the electromagnetic wave absorbing and shielding films installed in various communication cables provide an excellent effect on the electromagnetic compatibility.

As described above, the present invention provides the following advantageous effects.

The electromagnetic wave absorbing and shielding film, manufactured by forming a plate-like metal flake using a metal powder or ferrite powder, dispersing the metal flake into a binder solution, coating the resulting solution in which the metal flake is dispersed on a support capable of shielding electromagnetic wave, and drying the support coated with the metal flake is applied to an electrical wire and communication cable where electromagnetic wave is generated, thus absorbing and shielding electromagnetic wave and reducing noise.

Moreover, the electromagnetic wave absorbing and shielding film in accordance with the present invention is installed in a communication cable to wrap a communication line, a power line and an earth wire, thus absorbing and shielding electromagnetic wave generated from the communication cable and reducing noise between communication devices.

As above, preferred embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

What is claimed is:

1. A method of manufacturing an electromagnetic absorbing and shielding film, in which the method comprises forming a plate-like metal flake using a spherical metal alloy by an attrition mill, which operates at a predetermined speed for a predetermined time, with the addition of steel use stainless (SUS) balls or ceramic balls and surfactants, and washing the plate-like metal flake with ethyl alcohol, methyl alcohol or water and drying the washed metal flake, the method comprising:
dispersing powder capable of absorbing electromagnetic wave selected from the group consisting of Fe—Si alloy, Fe—Si—Cr alloy, amorphous substance, sendust (SDST) alloy, High-Flux powder, molypermalloy powder (MPP), pure iron alloy (Fe—Si, or Fe—Si—Cr), amorphous alloy (Fe—Si—Al—Cr), carbon coated iron, Ni—Zn ferrite powder, Mn—Zn ferrite powder, and a mixture thereof, into a binder solution, thus forming electromagnetic wave absorbing paint; and
coating the electromagnetic wave absorbing paint on the surface of a film capable of shielding electromagnetic wave and drying the resulting film, thus forming an electromagnetic wave absorbing and shielding film, of which one side is an electromagnetic wave absorbing layer having a thickness in a range of 10 to 100 μm and the other side is an electromagnetic wave shielding layer.

2. The method of claim 1, wherein the electromagnetic wave shielding layer is formed by one of the steps of:
1) laminating a metal thin film as an electrical conductive layer selected from the group consisting of aluminum foil, copper foil, silver foil, and nickel foil on a polymer film selected from the group consisting of polyethylene terephthalate, polyethylene naphthalate, polyaramide, polycarbonate, polyamide, polyimide, polyamideimide, and aramid;
2) depositing a metal component as an electrical conductive layer selected from the group consisting of Al, Cu, Ag, and Ni on the polymer film; and
3) dispersing a metal component as an electrical conductive layer selected from the group consisting of Al, Cu, Ag and Ni into a binder solution and coating the resulting solution on the polymer film,
wherein the electrical conductive layer has a thickness in a range of 5 to 20 μm, the polymer film has a thickness in a range of 12 to 50 μm, and the total thickness of the electromagnetic wave shielding layer is in a range of 17 to 70 μm.

3. An electromagnetic wave absorbing and shielding film manufactured by the method of claims 1 and 2.

4. A communication cable in which a communication line, a power line, and an earth wire are wrapped with an insulating coating, the communication cable comprising the electromagnetic wave absorbing and shielding film manufactured by the method of claims 1 and 2, wherein the electromagnetic wave absorbing and shielding film installed inside the insulating coating wraps the communication line, the power line and the earth wire, of which the electromagnetic wave shielding layer is arranged toward the communication line, the power line and the earth wire and the electromagnetic wave absorbing layer is arranged toward the insulating coating.

5. The communication cable of claim 4, wherein a drain wire having excellent electrical conductivity is arranged inside the electromagnetic wave shielding layer together with the communication line, the power line and the earth wire, and the electromagnetic wave shielding layer is grounded to the earth wire by the drain wire.
